(19) United States
(12) Patent Application Publication
(10) Pub. No.: US 2024/0029583 A1
(43) Pub. Date: Jan. 25, 2024

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi Aichi-ken (JP)

(72) Inventors: Yukiya KUSHIBIKI, Gifu-shi Gifu-ken (JP); Kota WASHIO, Sunto-gun Shizuoka-ken (JP); Akihito NAKAMURA, Toyota-shi Aichi-ken (JP); Takashi HATTORI, Toyota-shi Aichi-ken (JP); Yasuyuki KAMEZAKI, Toyota-shi Aichi-ken (JP); Masato ENDO, Nagoya-shi Aichi-ken (JP)

(73) Assignee: TOYOTA JIDOSHA KABUSHIKI KAISHA, Toyota-shi Aichi-ken (JP)

(21) Appl. No.: 18/210,734

(22) Filed: Jun. 16, 2023

(30) Foreign Application Priority Data
Jul. 19, 2022 (JP) 2022-115126

(51) Int. Cl. G09B 19/16; B60K 35/00

(52) U.S. Cl. CPC G09B 19/167; B60K 35/00; B60K 2370/16; B60K 2370/152; G09B 5/06

(57) ABSTRACT

An information processing device comprising a memory, and a processor coupled to the memory. The processor is configured to acquire vehicle information related to a vehicle, and, from among a plurality of instances of evaluation information including praise information for praising driving of a driver of the vehicle and including criticism information for criticizing the driving of the driver, cause one of the instances of evaluation information to be output from an output section provided in the vehicle, during driving of the vehicle, based on the acquired vehicle information.

### CROSS-REFERENCE TO RELATED APPLICATION

This application is based on and claims priority under 35 USC 119 from Japanese Patent Application No. 2022-115126 filed on Jul. 19, 2022, the disclosure of which is incorporated by reference herein.

### BACKGROUND

### Technical Field

The present disclosure relates to an information processing device, an information processing method, and a non-transitory storage medium.

### Related Art

For example, technology disclosed in Japanese Patent Application Laid-Open (JP-A) No. 2014-31050 is able to provide a diagnostic result corresponding to a driving skill of a driver, and is able to effectively utilize such a diagnostic result.

The technology disclosed in JP-A No. 2014-31050 presents a diagnostic result to a driver after driving has been performed, and the driver has not been able to immediately be made aware of an evaluation related to driving when specific driving has been performed.

### SUMMARY

The present disclosure provides an information processing device, information processing method, and a non-transitory storage medium that enable a driver to be made aware of an evaluation related to driving during driving of a vehicle.

An information processing device of a first aspect includes an acquisition section that acquires vehicle information related to a vehicle, and a control section that, from among plural evaluation information including praise information for praising driving of a driver of the vehicle and including criticism information for criticizing the driving of the driver, causes one of the instances of evaluation information to be output from an output section provided in the vehicle, during driving of the vehicle, based on the vehicle information acquired by the acquisition section.

In the information processing device of the first aspect the acquisition section acquires the vehicle information. The control section then causes one of the instances of evaluation information, from among the plural evaluation information including the praise information and the criticism information, to be output from the output section during driving of the vehicle, based on the vehicle information acquired by the acquisition section.

Thus in the information processing device, the driver is able to be made aware of the evaluation related to driving during driving of the vehicle by causing the evaluation information to be output from the output section during driving of the vehicle. More specifically, in the information processing device, the driver is able to be made aware of good points about their own driving and points for improvement with their own driving during driving of the vehicle.

An information processing device of a second aspect is the first aspect, wherein the vehicle information includes at least one of information indicating a driving operation of the driver, a state of the driver, or a current position of the vehicle.

In the information processing device of the second aspect, the vehicle information includes the at least one of information indicating a driving operation of the driver, a state of the driver, or a current position of the vehicle. Thus in the information processing device, during driving of the vehicle the driver is able to be made aware of the evaluation related to driving based on the at least one of information indicating a driving operation of the driver, a state of the driver, or a current position of the vehicle.

An information processing device of a third aspect is the first aspect, further including a counting section that counts a number of times in a case in which the evaluation information corresponds to the praise information, based on the vehicle information acquired by the acquisition section, and as the number of times counted by the counting section increases the control section reduces an output frequency at which the praise information is caused to be output from the output section during driving of the vehicle, in a log-periodic manner.

In the information processing device of the third aspect, the counting section counts the number of times in a case in which the evaluation information corresponds to the praise information, based on the vehicle information acquired by the acquisition section. As the number of times counted by the counting section increases, the control section reduces the output frequency at which the praise information is caused to be output from the output section during driving of the vehicle, in a log-periodic manner. Thus in the information processing device, a drop in the concentration on driving by the driver caused by output of the praise information can be suppressed compared to cases in which the praise information is output from the output section during driving of the vehicle each time the evaluation information corresponds to the praise information.

An information processing device of a fourth aspect is the third aspect, wherein in a case in which the praise information is caused to be output from the output section during driving of the vehicle after a reduction in the output frequency, the control section causes output of content differing to content prior to the reduction of the output frequency.

In the information processing device of the fourth aspect, the control section causes output of content differing to content prior to the reduction of the output frequency in a case in which the praise information is caused to be output from the output section during driving of the vehicle after the reduction in the output frequency. Thus in the information processing device, the attention of the driver to the praise information can be raised compared to cases in which the output content of the praise information is uniform.

An information processing device of a fifth aspect is any one of the first aspect to the fourth aspect, wherein from among the plural evaluation information the control section causes one of the instances of evaluation information that accords with an attribute of the driver to be output from the output section during driving of the vehicle.

In the information processing device of the fifth aspect, from among the plural evaluation information the control section causes the one evaluation information that accords with the attribute of the driver to be output from the output section during driving of the vehicle. Thus in the information processing device, a driver is able to be made aware of an evaluation related to driving as indicted by evaluation information appropriate to the attribute of the driver during driving of the vehicle.

An information processing device of a sixth aspect is any one of the first aspect to the fifth aspect, wherein from among plural of the output sections, the control section determines the output section for outputting the evaluation information during driving of the vehicle according to at least one of an attribute of the driver or a current date or time.

In the information processing device of the sixth aspect, from among the plural output sections the control section determines the output section for outputting the evaluation information during driving of the vehicle according to the at least one of an attribute of the driver or a current date or time. Thus in the information processing device, the evaluation information can be output during driving of the vehicle from the output section that is appropriate to the at least one of an attribute of the driver or a current date or time.

An information processing device of a seventh aspect is any one of the first aspect to the sixth aspect, wherein the control section causes the evaluation information to be output from the output section during driving of the vehicle within a specific period of time from when the acquisition section acquired the vehicle information.

In the information processing device of the seventh aspect the control section causes the evaluation information to be output from the output section during driving of the vehicle within the specific period of time from when the acquisition section acquired the vehicle information. Thus in the information processing device, the driver is able to more easily be made aware of the driving content corresponding to the evaluation information output during driving of the vehicle than in a case in which the evaluation information is output after the specific period of time has been exceeded from when the vehicle information was acquired.

An information processing method of an eighth aspect is processing executed by a processor. The processing includes acquiring vehicle information related to a vehicle, and from among plural evaluation information including praise information for praising driving of a driver of the vehicle and including criticism information for criticizing the driving of the driver, causing one of the instances of evaluation information to be output from an output section provided in the vehicle, during driving of the vehicle, based on the acquired vehicle information.

A non-transitory storage medium of a ninth aspect causes processing to be executed by a processor. The processing includes acquiring vehicle information related to a vehicle, and from among plural evaluation information including praise information for praising driving of a driver of the vehicle and including criticism information for criticizing the driving of the driver, causing one of the instances of evaluation information to be output from an output section provided in the vehicle, during driving of the vehicle, based on the acquired vehicle information.

As described above, in the information processing device, information processing method, and non-transitory storage medium according to the present disclosure, a driver is able to be made aware of an evaluation related to driving during driving of a vehicle.

### BRIEF DESCRIPTION OF THE DRAWINGS

Exemplary embodiments of the present disclosure will be described in detail based on the following figures, wherein:

FIG. 1 is a diagram illustrating a schematic configuration of an information processing system according to an exemplary embodiment;

FIG. 2 is a block diagram illustrating a hardware configuration of a vehicle according to an exemplary embodiment;

FIG. 3 is a block diagram illustrating a configuration of a storage section of a vehicle according to an exemplary embodiment;

FIG. 4 is a first block diagram illustrating an example of a functional configuration of an onboard device according to an exemplary embodiment;

FIG. 5 is a block diagram illustrating a hardware configuration of a management server and a driver terminal;

FIG. 6 is a first flowchart illustrating a flow of decision processing by an onboard device according to an exemplary embodiment;

FIG. 7A is a first explanatory diagram illustrating an output example of instances of evaluation information output to a MID during driving of a vehicle according to an exemplary embodiment;

FIG. 7B is a first explanatory diagram illustrating an output example of instances of evaluation information output from a speaker during driving of a vehicle according to an exemplary embodiment;

FIG. 8 is a second block diagram illustrating an example of a functional configuration of an onboard device according to an exemplary embodiment;

FIG. 9 is a second flowchart illustrating a flow of decision processing by an onboard device according to an exemplary embodiment;

FIG. 10A is a second explanatory diagram illustrating an output example of instances of evaluation information output to a MID during driving of a vehicle according to an exemplary embodiment;

FIG. 10B is a third explanatory diagram illustrating an output example of instances of evaluation information output to a MID during driving of a vehicle according to an exemplary embodiment;

FIG. 11A is a second explanatory diagram illustrating an output example of instances of evaluation information output from a speaker during driving of a vehicle according to an exemplary embodiment; and

FIG. 11B is a third explanatory diagram illustrating an output example of instances of evaluation information output from a speaker during driving of a vehicle according to an exemplary embodiment.

### DETAILED DESCRIPTION

Description follows regarding an information processing system 10 according to an exemplary embodiment.

The information processing system 10 according to the present exemplary embodiment is a system that enables a driver to be made aware of an evaluation related to driving during driving of a vehicle

### First Exemplary Embodiment

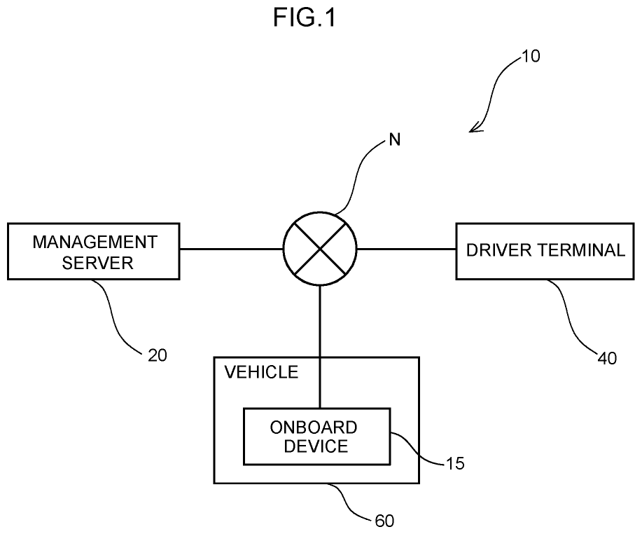

First description follows regarding a first exemplary embodiment of the information processing system 10 according to the present exemplary embodiments. FIG. 1 is a diagram illustrating a schematic configuration of the information processing system 10.

As illustrated in FIG. 1, the information processing system 10 includes a management server 20, a driver terminal 40, and a vehicle 60. The management server 20, the driver terminal 40, and an onboard device 15 installed to the vehicle 60 are connected together over a network N, so as to be able to communicate with each other. The onboard device 15 is an example of an “information processing device”.

The management server 20 is a server computer owned by a specific business.

The driver terminal 40 is a mobile terminal owned by a driver of the vehicle 60. Examples of devices applicable as the driver terminal 40 include a portable personal computer (notebook PC), a smartphone, or a tablet terminal. In the first exemplary embodiment the driver terminal 40 is, as an example, a smartphone.

The vehicle 60 may be any vehicle from among a gasoline engine vehicle, a hybrid vehicle, a plug-in hybrid vehicle, a fuel cell vehicle, or an electric car. In the first exemplary embodiment the vehicle 60 is, as an example, a gasoline engine vehicle.

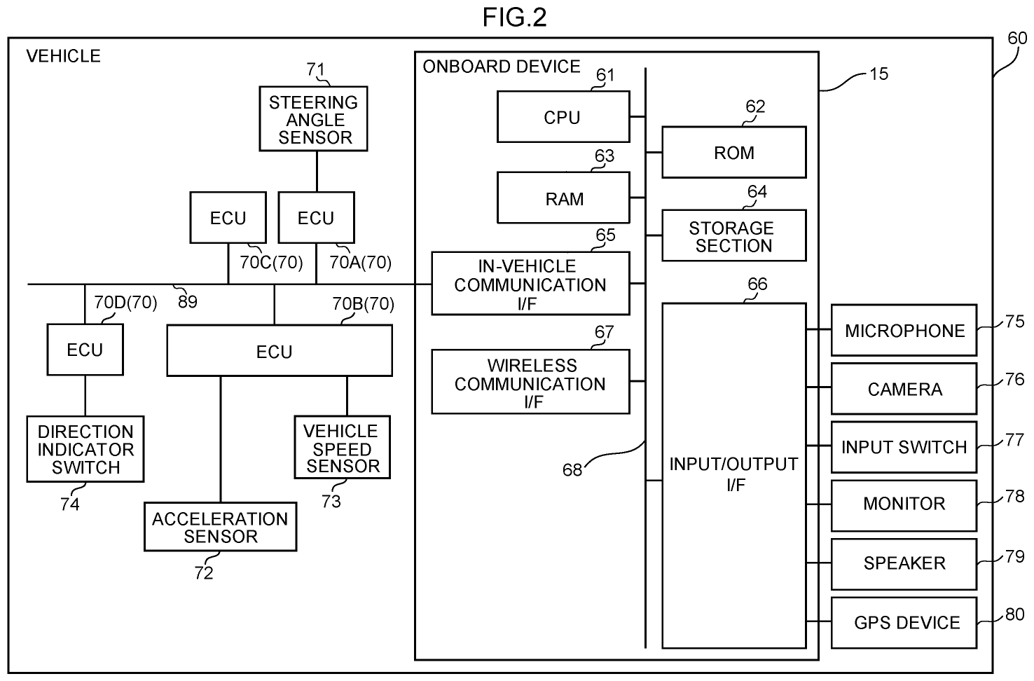

Next, description follows regarding a hardware configuration of the vehicle 60. FIG. 2 is a block diagram illustrating a hardware configuration of the vehicle 60.

As illustrated in FIG. 2, the vehicle 60 is configured including the onboard device 15, plural electronic control units (ECU) 70, a steering angle sensor 71, an acceleration sensor 72, a vehicle speed sensor 73, direction indicator switches 74, a microphone 75, a camera 76, an input switch 77, a monitor 78, a speaker 79, and a GPS device 80.

The onboard device 15 is configured including a central processing unit (CPU) 61, read only memory (ROM) 62, random access memory (RAM) 63, a storage section 64, an in- vehicle communication interface (I/F) 65, an input/output I/F 66, and a wireless communication I/F 67. The CPU 61, the ROM 62, the RAM 63, the storage section 64, the in-vehicle communication I/F 65, the input/output I/F 66, and the wireless communication I/F 67 are connected together through an internal bus 68 so as to be able to communicate with each other.

The CPU 61 is a central processing unit that executes various programs, and controls each section. Namely, the CPU 61 serves as a processor and reads a program from the ROM 62 serving as memory or the storage section 64 serving as memory, and executes the program using the RAM 63 as a workspace. The CPU 61 controls each configuration and performs various processing according to the program stored on the ROM 62 or the storage section 64.

The ROM 62 stores various programs and various data. The RAM 63 functions as workspace to temporarily store a program and data.

The storage section 64 is configured from a storage device, such as an embedded Multi Media Card (e-MMC) or Universal Flash Storage (UFS), and is stored with various programs and various data.

The in-vehicle communication I/F 65 is an interface for connecting to the ECUs 70. This interface employs a communication standard such as a CAN protocol. The in-vehicle communication I/F 65 is connected to an external bus 89.

Plural of the ECUs 70 are provided so as to cover each function of the vehicle 60, and in the first exemplary embodiment an ECU 70A, ECU 70B, ECU 70C, and ECU 70D are provided. The ECU 70A is an example of an ECU employed in electric power steering, and the steering angle sensor 71 is connected to the ECU 70A. The ECU 70B is an example of an ECU employed in vehicle stability control (VSC), and the acceleration sensor 72 and the vehicle speed sensor 73 are connected to the ECU 70B. In addition to the acceleration sensor 72 and the vehicle speed sensor 73, a yaw rate sensor may also be connected to the ECU 70B.

The ECU 70C is an example of an engine ECU, and detects engine revolution rate and engine torque of the vehicle 60 for controlling the engine. The ECU 70C detects an accelerator operation of the vehicle 60. The engine revolution rate, engine torque, and accelerator operation detected by the ECU 70C are stored in the storage section 64. The ECU 70D is an example of a steering ECU, and the direction indicator switches 74 are connected to the ECU 70D. The direction indicator switches 74 are provided to a steering column for operating direction indicators. The ECU 70D detects operation of the direction indicator switches 74 by the driver as direction indicator operations. The direction indicator operations detected by the ECU 70D are stored in the storage section 64.

The steering angle sensor 71 is a sensor for detecting a steering angle of a steering wheel. The steering angle detected by the steering angle sensor 71 is stored in the storage section 64.

The acceleration sensor 72 is a sensor for detecting an acceleration acting on the vehicle 60. The acceleration sensor 72 is, as an example, a tri-axial acceleration sensor, and detects acceleration applied in a vehicle front-rear direction as an X axis direction, in a vehicle width direction as a Y axis direction, and in a vehicle height direction as a Z axis direction. The accelerations detected by the acceleration sensor 72 are stored in the storage section 64.

The vehicle speed sensor 73 is a sensor for detecting a vehicle speed of the vehicle 60. The vehicle speed sensor 73 is, for example, a sensor provided to a vehicle wheel. The vehicle speed as detected by the vehicle speed sensor 73 is stored in the storage section 64.

The input/output I/F 66 is an interface for communication with the microphone 75, the camera 76, the input switch 77, the monitor 78, the speaker 79, and the GPS device 80 installed in the vehicle 60.

The microphone 75 is provided to a front pillar, a dashboard, or the like of the vehicle 60, and is a device that picks up speech spoken by the driver of the vehicle 60. Note that the microphone 75 may be provided to the camera 76, described below.

The camera 76 is an imaging device that captures images using an imaging element such as, for example, a charge coupled device (CCD) image sensor or a complementary metal oxide semiconductor (CMOS) image sensor, or the like. The camera 76 includes, as an example, a first camera provided to an upper portion of a front window or dashboard of the vehicle 60 so as to face toward the driver, or a second camera provided to a front section of the vehicle 60 for imaging in front of the vehicle. The images captured by the first camera of the camera 76 are, as an example, employed to detect a facial expression of the driver. The images captured by the second camera of the camera 76 are, as an example, employed to recognize an inter-vehicle distance to a vehicle ahead traveling in front of the vehicle, a vehicle lane, a traffic signal, and the like. The images captured by the camera 76 are stored in the storage section 64. The camera 76 may be configured by an imaging device for another application such as a drive recorder, an advance driver assistance system (ADAS), or the like. The camera 76 may be connected to the onboard device 15 via another ECU 70 (for example, a camera ECU).

The input switch 77 is provided to an instrument panel, a center console, the steering wheel, or the like, and is a switch for inputting operation by a finger of the driver. Examples of switches that may be applied as the input switch 77 include, for example, a push-button style ten key, a touch pad, or the like.

The monitor 78 is provided to the instrument panel, to a meter panel, or the like, and is a liquid crystal monitor for displaying proposed actions related to the functions of the vehicle 60, images related to explanation of such functions, or the like. The monitor 78 may be provided by a touch panel that also serves as the input switch 77.

The speaker 79 is provided to the instrument panel, the center console, the front pillar, the dashboard, or the like, and is a device for outputting proposed actions related to the functions of the vehicle 60, speech related to explanation of such functions, or the like. The speaker 79 may be provided to the monitor 78.

In the first exemplary embodiment, evaluation information is output from the monitor 78 and the speaker 79 during driving of the vehicle 60. This evaluation information is information indicating an evaluation related to driving of the driver, and plural items are provided thereof, including praise information to praise the driving of the driver, and criticism information to criticize the driving of the driver. Examples of praise information items include a “praise item A” to indicate that the driver has stopped at a stop sign, a “praise item B” to indicate good braking operation of the driver, a “praise item C” to indicate good acceleration operation of the driver, and the like. Examples of criticism information items include “criticism item A” to indicate that the driver did not stop at a stop sign, a “criticism item B” to indicate that the braking operation of the driver was bad, a “criticism item C” to indicate that the driver has been driving while falling asleep, a “criticism item D” to indicate that the vehicle 60 is positioned in a no-entry road, a “criticism item E” to indicate that driving was at a speed exceeding the maximum speed limit, a “criticism item F” to indicate that the acceleration operation of the driver was bad, and the like. Note that the monitor 78 and the speaker 79 are an example of an “output section”.

The GPS device 80 is a device for determining a current position of the vehicle 60. The GPS device 80 includes a non-illustrated antenna for receiving signals from GPS satellites. Note that the GPS device 80 may be connected to the onboard device 15 via a car navigation system connected to one of the ECUs 70 (a multimedia ECU, for example).

The wireless communication I/F 67 is a wireless communication module for communication with the management server 20. This wireless communication module employs, for example, a communication standard such as 5G, LTE, or Wi-Fi (registered trademark). The wireless communication I/F 67 is connected to the network N.

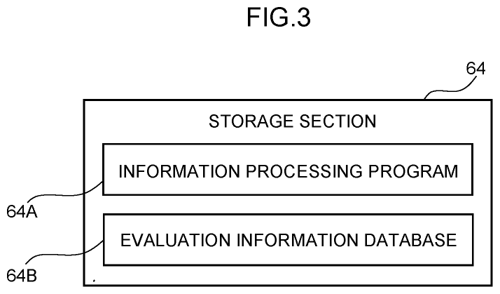

FIG. 3 is a block diagram illustrating a configuration of the storage section 64 of the vehicle 60.

As illustrated in FIG. 3, an information processing program 64A to cause decision processing to be executed by the CPU 61 of the onboard device 15, described later, and an evaluation information database 64B are stored in the storage section 64. When executing the information processing program 64A, the onboard device 15 employs the hardware resources illustrated in FIG. 2 to execute processing based on the information processing program 64A.

Each of plural items of instances of evaluation information are stored in the evaluation information database 64B associated with corresponding vehicle information related to the vehicle 60. This thereby enables an evaluation information item corresponding to vehicle information to be extracted from the evaluation information database 64B when the CPU 61 of the onboard device 15 has acquired such vehicle information. Furthermore, output content for output from the monitor 78 and the speaker 79 corresponding to each of the plural items of instances of evaluation information is stored in the evaluation information database 64B.

Next, description follows regarding a functional configuration of the onboard device 15.

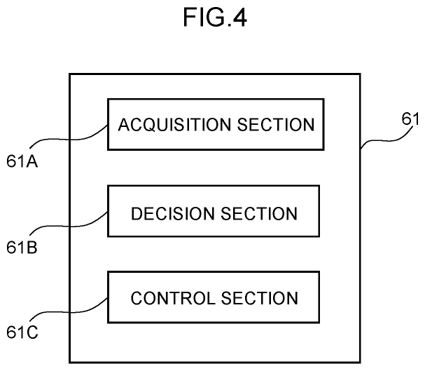

FIG. 4 is a first block diagram illustrating an example of a functional configuration of the onboard device 15.

As illustrated in FIG. 4, the CPU 61 of the onboard device 15 includes, from a functional perspective, an acquisition section 61A, a decision section 61B, and a control section 61C. Each of the functional configuration is implemented by the CPU 61 reading out and executing the information processing program 64A stored on the storage section 64.

The acquisition section 61A acquires the vehicle information. More specifically, as the vehicle information, the acquisition section 61A acquires information indicating a driving operation of the driver (hereafter referred to as “driving operation information”), a state of the driver, or a current position of the vehicle 60.

For example, the acquisition section 61A acquires, as the driving operation information, a steering angle, acceleration, vehicle speed, and direction indicator operation of the vehicle 60, as respectively detected by the steering angle sensor 71, the acceleration sensor 72, the vehicle speed sensor 73, and the direction indicator switches 74. The acquisition section 61A also acquires, as the driving operation information, the engine revolution rate, the engine torque, and the accelerator operation of the vehicle 60 as detected by the ECU 70C.

For example, the acquisition section 61A acquires, as the state of the driver, images captured by the first camera of the camera 76, and more specifically images capturing the face of the driver. The acquisition section 61A acquires a current position of the vehicle 60 as measured by the GPS device 80.

Note that the information described above is part of the vehicle information acquirable by the acquisition section 61A, and information related to the vehicle 60 other than the information listed above is also acquired as vehicle information by the acquisition section 61A.

The decision section 61B extracts from the evaluation information database 64B evaluation information items corresponding to the vehicle information acquired by the acquisition section 61A, and determines an evaluation information item to output from the monitor 78 and the speaker 79.

For example, the decision section 61B determines the “praise item B” or the “criticism item B” as the evaluation information item to output from the monitor 78 and the speaker 79 from among the driving operation information acquired as vehicle information by the acquisition section 61A. The decision section 61B detects a facial expression of the driver from a state of the driver as acquired by the acquisition section 61A as the vehicle information and, for example, determines the “criticism item C” as the evaluation information item to output from the monitor 78 and the speaker 79. Furthermore, from the current position of the vehicle 60, as acquired by the acquisition section 61A as the vehicle information, the decision section 61B determines, for example, a “criticism item D” as the evaluation information item to output from the monitor 78 and the speaker 79.

The control section 61C causes evaluation information to be output from the monitor 78 and the speaker 79 during driving of the vehicle 60 that is evaluation information corresponding to one item determined by the decision section 61B from among the plural items of instances of evaluation information contained in the praise items and criticism items. The control section 61C causes such evaluation information to be output from the monitor 78 and the speaker 79 during driving of the vehicle 60 within a specific period of time, a few seconds for example, from when the acquisition section 61A acquired the vehicle information.

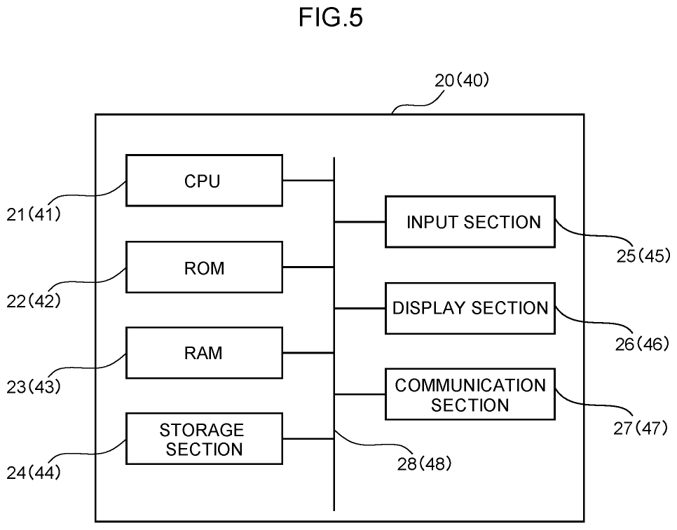

Next, description follows regarding a hardware configuration of the management server 20 and the driver terminal 40. FIG. 5 is a block diagram illustrating a hardware configuration of the management server 20 and the driver terminal 40. Note that since the management server 20 and the driver terminal 40 are basically configured with a configuration of a general purpose computer, description will focus on the management server 20 as representative thereof.

As illustrated in FIG. 5, the management server 20 includes a CPU 21, ROM 22, RAM 23, a storage section 24, an input section 25, a display section 26, and a communication section 27. The driver terminal 40 includes a CPU 41, ROM 42, RAM 43, a storage section 44, an input section 45, a display section 46, and a communication section 47. Each configuration is connected together through a bus 28 (bus 48) so as to be able to communicate with each other.

The CPU 21 is a central processing unit that executes various programs, and controls each section. Namely, the CPU 21 reads a program from the ROM 22 or the storage section 24, and executes the program using the RAM 23 as a workspace. The CPU 21 controls each configuration and performs various computational processing according to the program stored on the ROM 22 or the storage section 24.

The ROM 22 stores various programs and various data. The RAM 23 serves as a workspace to temporarily store programs or data.

The storage section 24 is configured by a storage device, such as a hard disk drive (HDD), solid state drive (SSD), or flash memory, and is stored with various programs and various data.

The input section 25 includes a pointer device such as a mouse, a keyboard, a microphone, a camera, and the like and is employed to perform various inputs.

The display section 26 is, for example, a liquid crystal display, and displays various information. The display section 26 may also be a touch panel type display section that also functions as the input section 25.

The communication section 27 serves as an interface for communication with other devices. This communication may, for example, employ a wired communication standard such as Ethernet (registered trademark) or FDDI, or employ a wireless communication standard such as 4G, 5G, Bluetooth (registered trademark), or Wi-Fi (registered trademark).

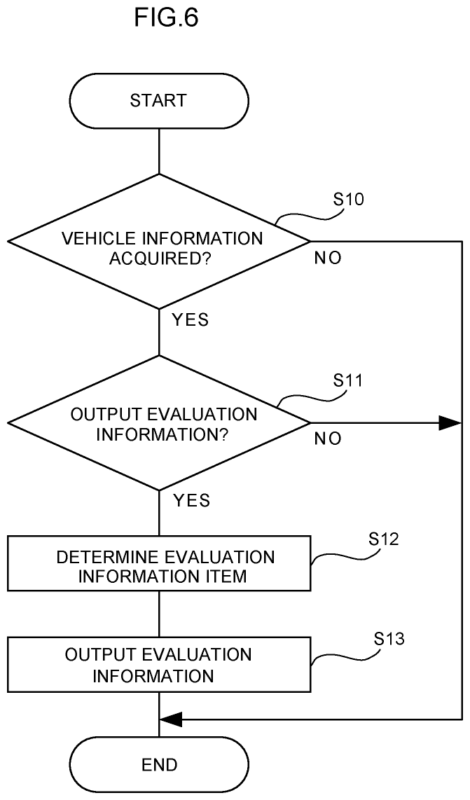

FIG. 6 is a first flowchart illustrating a flow of decision processing to determine whether or not to output evaluation information during driving of the vehicle 60 using the onboard device 15. The CPU 61 reads the information processing program 64A from the storage section 64, expands the information processing program 64A in the RAM 63, and executes the information processing program 64A so as to perform the decision processing.

At step S10 of FIG. 6, the CPU 61 determines whether or not vehicle information has been acquired, and proceeds to step Sll in a case in which determination is that vehicle information has been acquired (step S10: YES). However, the decision processing is ended in a case in which determination by the CPU 61 is that vehicle information has not been acquired (step S10: NO).

At step S11, based on the vehicle information acquired at step S10, the CPU 61 determines whether or not to cause evaluation information to be output, and processing proceeds to step S12 in a case in which determination was to cause evaluation information to be output (step S11: YES). However, the decision processing is ended in a case in which determination by the CPU 61 is not to output evaluation information (step S11: NO). As an example, the CPU 61 determines to cause evaluation information to be output in a case in which the vehicle information acquired at step S10 satisfies a specific output condition, and determines to not output evaluation information in a case in which the specific output condition is not satisfied.

At step S12 the CPU 61 determines an evaluation information item corresponding to the vehicle information acquired at step S10. More specifically, the CPU 61 extracts an evaluation information item corresponding the vehicle information acquired at step S10 from the evaluation information database 64B, and determines the evaluation information item to output from the monitor 78 and the speaker 79. Processing then proceeds to step S13.

At step S13, the CPU 61 causes the evaluation information corresponding to the item determined at step S12 to be output from the monitor 78 and the speaker 79 during driving of the vehicle 60. The decision processing is then ended.

Next, description follows regarding a result of performing the decision processing illustrated in FIG. 6 by the onboard device 15, and regarding an example of output of the instances of evaluation information output from the monitor 78 and the speaker 79.

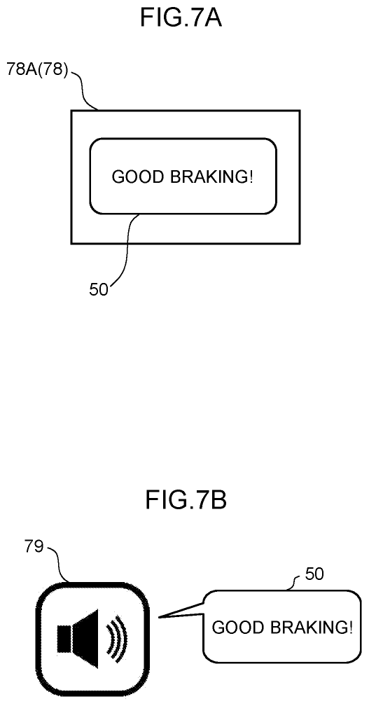

FIG. 7A is an explanatory diagram regarding an example of instances of evaluation information output from the monitor 78 during driving of the vehicle 60, and more specifically output by a multi information display (hereafter referred to as “MID”) 78A. FIG. 7A is, as an example, text of “Good Braking!” output by the MID 78A as praise information 50 corresponding to the praise item B.

FIG. 7B is an explanatory diagram illustrating an example of output of instances of evaluation information output from the speaker 79 during driving of the vehicle 60. In FIG. 7B, as an example, speech of “Good Braking!” is output from the speaker 79 as the praise information 50 corresponding to the praise item B.

As described above, in the onboard device 15 the CPU 61 acquires the vehicle information. The CPU 61 then, based on the acquired vehicle information, causes one evaluation information from among the plural evaluation information included in the praise information and the criticism information to be output from the monitor 78 and the speaker 79 during driving of the vehicle 60. Thus in the onboard device 15, the driver is able to be made aware of an evaluation related to driving during driving of the vehicle 60 by the evaluation information being output from the monitor 78 and the speaker 79 during driving of the vehicle 60. More specifically, in the onboard device 15 the driver is able to be made aware of good points about their own driving and points for improvement with their own driving during driving of the vehicle 60.

The vehicle information described above includes driving operation information, a state of the driver, and the current position of the vehicle 60. Thereby in the onboard device 15 the driver is able to be made aware of the evaluation related to driving during driving of the vehicle 60, based on the driving operation information, the state of the driver, and the current position of the vehicle 60.

Moreover in the onboard device 15, during driving of the vehicle 60 the CPU 61 is able to cause the evaluation information to be output from the monitor 78 and the speaker 79 within a specific period of time from when the vehicle information was acquired. Thus in the onboard device 15 it is easier for the driver to be made aware of driving content corresponding to the evaluation information output during driving of the vehicle 60 than cases in which the evaluation information is output only after the specific period of time has elapsed from when the vehicle information was acquired. Second Exemplary Embodiment

Next, description follows regarding a second exemplary embodiment of the information processing system 10 according to the present exemplary embodiments, with duplicate explanation of parts thereof common to other exemplary embodiments either abbreviated or omitted.

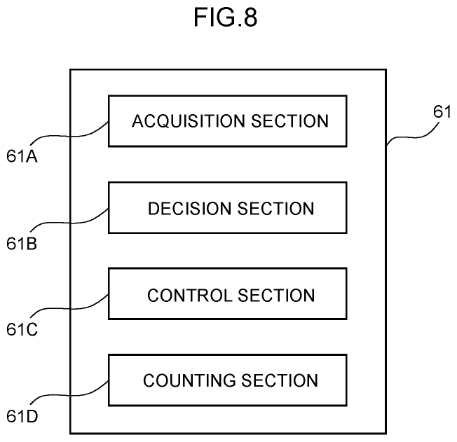

FIG. 8 is a second block diagram illustrating an example of a functional configuration of the onboard device 15.

As illustrated in FIG. 8, the CPU 61 of the onboard device 15 includes, from a functional perspective, an acquisition section 61A, a decision section 61B, a control section 61C, and a counting section 61D.

Based on the vehicle information acquired by the acquisition section 61A, the counting section 61D counts the number of times the evaluation information corresponds to praise information. In other words, the counting section 61D counts the number of times praiseworthy driving was performed by the driver. The number of times counted by the counting section 61D is stored in the storage section 64 associated with the praise item corresponding to the praise information.

The control section 61C of the second exemplary embodiment then reduces an output frequency with which praise information is output from the monitor 78 and the speaker 79 during driving of the vehicle 60 in a log-periodic manner as the number of times counted by the counting section 61D increases. As an example, the control section 61C outputs the praise information at a periodicity of once every time for count numbers of from 1 to 10, outputs at a periodicity of once every 10 times for count numbers of from 11 to 100, and outputs at a periodicity of once every 100 times for count numbers of from 101 to 1000.

In a case in which the praise information is caused to be output from the monitor 78 and the speaker 79 during driving of the vehicle 60 after the output frequency has been reduced, the control section 61C causes this output to be content that is different to content prior to reducing the output frequency.

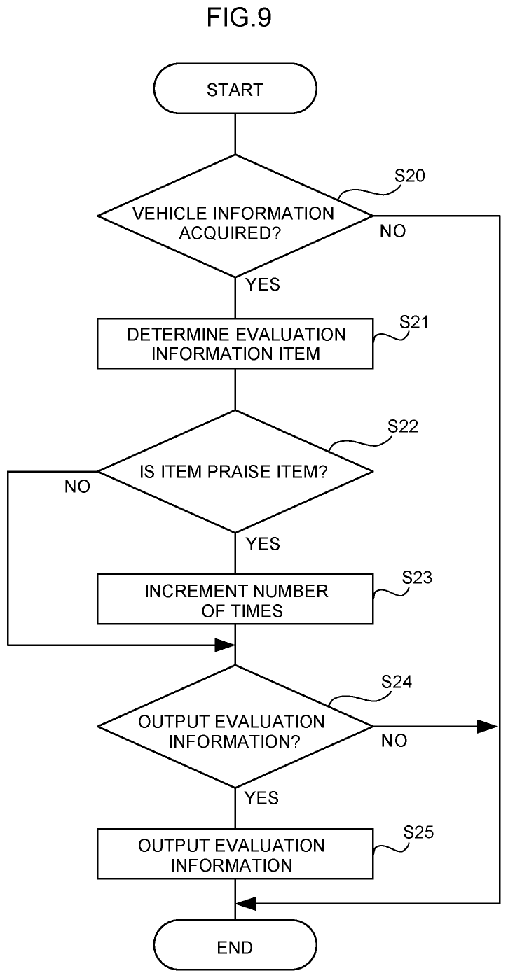

FIG. 9 is a second flowchart illustrating a flow of decision processing by the onboard device 15.

At step S20 in FIG. 9, the CPU 61 determines whether or not the vehicle information has been acquired, and proceeds to step S21 in a case in which vehicle information is determined to have been acquired (step S20: YES). However, the decision processing is ended in a case in which determination by the CPU 61 is that the vehicle information has not been acquired (step S20: NO).

At step S21, the CPU 61 determines an item of instances of evaluation information corresponding to the vehicle information acquired at step S20. Processing then proceeds to step S22.

At step S22, the CPU 61 determines whether or not the evaluation information item determined at step S21 corresponds a praise item, and processing proceeds to step S23 in a case in which determination is that the evaluation information item corresponds to a praise item (step S22: YES). However, the processing proceeds to step S24 in a case in which determination by the CPU 61 is that it does not correspond to praise information, in other words that it corresponds to a criticism item (step S22: NO).

At step S23, the CPU 61 adds “1” to the count number of praise items determined at step S21. Processing then proceeds to step S24.

At step S24, based on the vehicle information acquired at step S20 the CPU 61 determines whether or not to cause evaluation information to be output, and processing proceeds to step S25 in a case in which determination is to cause the evaluation information to be output (step S24: YES). However, the decision processing is ended in a case in which determination by the CPU 61 is not to output the evaluation information (step S24: NO). As an example, in a case in which the CPU 61 has determined the evaluation information item to be a criticism item at step S21, the CPU 61 determines to output the evaluation information when a specific output condition has been satisfied, and determines to not output the evaluation information in a case in which the specific output condition has not been satisfied. However, the CPU 61 determines to cause evaluation information to be output in a case in which the evaluation information item has been determined to be a praise item at step S21 and the count number resulting from the adding at step S23 matches the output periodicity, and determines to not output the evaluation information in a case in which the output periodicity is not matched.

At step S25, the CPU 61 causes the evaluation information corresponding to the item determined at step S21 to be output from the monitor 78 and the speaker 79 during driving of the vehicle 60. The decision processing is then ended.

Next, description follows regarding a result of the decision processing illustrated in FIG. 9 performed by the onboard device 15, and an output example of instances of evaluation information output from the monitor 78 and the speaker 79.

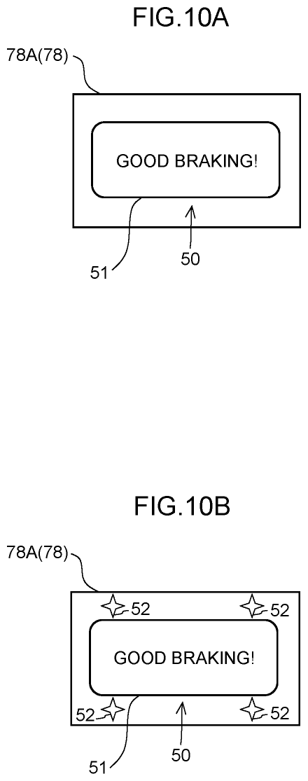

FIG. 10 is an explanatory diagram to indicate an example of output of instances of evaluation information output by the MID 78A during driving of the vehicle 60. More specifically, FIG. 10A is an example of output of praise information output by the MID 78A while the count number is from 1 time to 10 times, and FIG. 10B is an example of output of praise information output by the MID 78A while the count number is from 11 times to 100 times.

FIG. 10A and FIG. 10B illustrated, as an example, output by the MID 78A of text information 51 of “Good Braking!” as the praise information 50 corresponding to the praise item B. FIG. 10B illustrates four star marks 52, which were not displayed in FIG. 10A, displayed at the periphery of the text information 51 as the praise information 50.

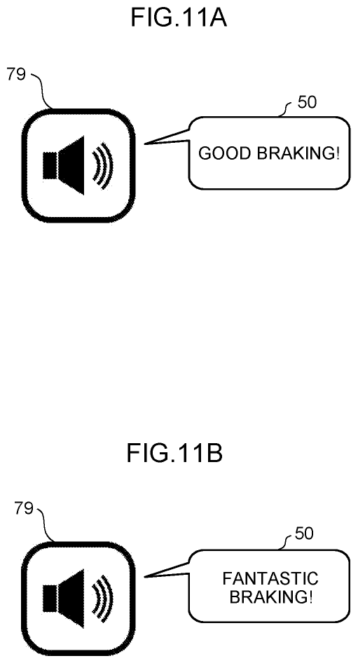

FIG. 11 is an explanatory diagram illustrating an example of output of instances of evaluation information output from the speaker 79 during driving of the vehicle 60. More specifically, FIG. 11A illustrates an output example of praise information output from the speaker 79 for a period in which the count number is between 1 time and 10 times, and FIG. 11B illustrates an output example of praise information output from the speaker 79 for a period in which the count number is between 11 times and 100 times.

FIG. 11A illustrates, as an example, speech output from the speaker 79 of “Good Braking!” as the praise information 50 corresponding to the praise item B. Moreover, FIG. 11B illustrates, as an example, speech output from the speaker 79 of “Fantastic Braking!” as the praise information 50 corresponding to the praise item B.

As described above, in the second exemplary embodiment the content of the praise information output from the monitor 78 and the speaker 79 in a period when the count number is from 11 times to 100 times differs from the content of the praise information output from the monitor 78 and the speaker 79 in a period when the count number is from 1 time to 10 times.

As described above, in the onboard device 15, based on the acquired vehicle information the CPU 61 counts the number of times in a case in which the evaluation information corresponds to the praise information. Then the CPU 61 reduces the output frequency for causing the praise information to be output from the monitor 78 and the speaker 79 during driving of the vehicle 60 in a log-periodic manner as the number of times that was counted increases. Thereby in the onboard device 15, a drop in concentration on driving by the driver caused by output of the praise information can be suppressed compared to cases in which the praise information is output from the monitor 78 and the speaker 79 during driving of the vehicle 60 each time the evaluation information corresponds to the praise information.

In the onboard device 15, in a case in which praise information is caused to be output from the monitor 78 and the speaker 79 during driving of the vehicle 60 after the output frequency has been reduced, the CPU 61 causes content to be output from the monitor 78 and the speaker 79 that differs from content prior to the output frequency being reduced. Thus in the onboard device 15, attention of the driver to the praise information can be raised compared to cases in which the output content of the praise information is uniform.

### Third Exemplary Embodiment

Next, a description follows regarding a third exemplary embodiment of the information processing system 10 according to the present exemplary embodiments, with duplicate explanation of parts thereof common to other exemplary embodiments either abbreviated or omitted.

Individual characteristic information indicating individual characteristics of the driver of the vehicle 60 is stored in the storage section 64 of the vehicle 60 of the third exemplary embodiment. The individual characteristic information includes, as an example, an age, gender, personality, or the like of the driver. The individual characteristic information is generated based on results of a check executed on the driver of the vehicle 60 to estimate individual characteristics. For example, individual characteristic information of “Age: 35, Gender: Male, Personality: Impatient” is generated and stored in the storage section 64 associated with the driver. The individual characteristics of the driver are an example of a “driver attribute”.

In the onboard device 15 of the third exemplary embodiment, the CPU 61 functions as the control section 61C, and causes the evaluation information of one item corresponding to the individual characteristics of the driver from among plural evaluation information items to be output from the monitor 78 and the speaker 79 during driving of the vehicle 60.

For example, based on the acquired vehicle information the CPU 61 detects driving of the driver corresponding to the criticism item E and the criticism item F from among the instances of evaluation information items. The CPU 61 then, based on the individual characteristic information of the driver, determines there to be a high possibility of enraging the driver were a speed violation to be pointed out to this driver. In such cases, instead of criticism information corresponding to the criticism item E to criticize a speed violation the CPU 61 causes criticism information corresponding to criticism item F to criticize an acceleration operation to be output from the monitor 78 and the speaker 79 during driving of the vehicle 60.

Due to adopting the configuration described above, in the onboard device 15 of the third exemplary embodiment, the driver during driving of the vehicle 60 is thereby able to be made aware of an evaluation related to driving as indicated by evaluation information appropriate to an attribute of the driver.

### Fourth Exemplary Embodiment

Next, description follows regarding a fourth exemplary embodiment of the information processing system 10 according to the present exemplary embodiments, with description of common parts to other exemplary embodiments either abbreviated or omitted.

Individual characteristic information indicating the individual characteristics of the driver of the vehicle 60 is stored in the storage section 64 of the vehicle 60 of the fourth exemplary embodiment, similarly to in the third exemplary embodiment.

In the onboard device 15 of the fourth exemplary embodiment, the CPU 61 functions as the control section 61C, and determines to cause evaluation information to be output from one out of the monitor 78 or the speaker 79 during driving of the vehicle 60 according to the individual characteristics of the driver. For example, the CPU 61 determines whether or not the driver has a tendency toward being hard of hearing based on the acquired individual characteristic information of the driver. In such cases the CPU 61 determines to stop output of instances of evaluation information from the speaker 79, and to cause the evaluation information to be output from the monitor 78 alone.

Adopting such a configuration enables, in the onboard device 15 of the fourth exemplary embodiment, evaluation information to be output during driving of the vehicle 60 from a configuration appropriate to the individual characteristics of the driver.

### Other

Although in the above exemplary embodiments the onboard device 15 is employed as an example of the information processing device, there is no limitation thereto, and the management server 20 or the driver terminal 40 may be employed as an example of the information processing device, and a combination of the onboard device 15, the management server 20 and the driver terminal 40 may be employed as an example of the information processing device. For example, in a case in which a combination of the onboard device 15 with the management server 20 is employed as an example of the information processing device, at least part of the functional configurations of the CPU 61 of the onboard device 15 as illustrated in FIG. 4 or FIG. 8 may be performed by the CPU 21 of the management server 20 as illustrated in FIG. 5. In such cases, the decision processing illustrated in FIG. 6 or FIG. 9 may be executed by one processor from among the CPU 21 of the management server 20 or the CPU 61 of the onboard device 15, or may be executed by a combination of plural processors of the CPU 21 of the management server 20 and the CPU 61 of the onboard device

Although the above exemplary embodiments the monitor 78 and the speaker 79 are employed as an example of an output section, there is no limitation thereto, and one out of the monitor 78 or the speaker 79 may be employed as an example of an output section. Moreover, the monitor 78 for outputting the evaluation information is not limited to being the MID 78A, and may be another monitor 78, such as a head-up display or the like. Furthermore, an example of the output section is not limited to the configurations provided to the vehicle 60. For example, evaluation information for output from the onboard device 15 or the management server 20 may be transmitted to the driver terminal 40, and the evaluation information may be output from at least one of a display section 46 or a non-illustrated speaker of the driver terminal 40 placed inside the vehicle 60 during driving of the vehicle 60. In such cases at least one of the display section 46 or the speaker of the driver terminal 40 is employed as an example of the output section.

In the above exemplary embodiments the vehicle information includes the driving operation information, the state of the driver, and the current position of the vehicle 60, however there is no limitation thereto, and the vehicle information may include at least one of the driving operation information, the state of the driver, and the current position of the vehicle 60.

Although in the above exemplary embodiments the individual characteristics of the driver are employed as an example of an attribute of the driver, a driving skill of the driver may be employed as an example of the attribute of the driver, either instead of, or in addition thereto.

In the above exemplary embodiment the CPU 61 performed a decision to cause evaluation information to be output from one or other out of the monitor 78 or the speaker 79 during driving of the vehicle 60 according to the individual characteristics of the driver. However, either instead of, or in addition thereto, the CPU 61 may perform a decision to cause evaluation information to be output from one or other out of the monitor 78 or the speaker 79 during driving of the vehicle 60 according to the current date or time. For example, the CPU 61 may perform a decision to cause output of instances of evaluation information to the monitor 78 to be stopped and to cause evaluation information to be output from the speaker 79 alone when determined, based on an acquired current date or time, to be in a time band when there is often a tendency for the driver to feel sleepy, be distracted, and feel tired etc., or to be in a time band when accidents often occur.

In the exemplary embodiments described above the CPU 61 may cause the evaluation information to be output from the monitor 78 and the speaker 79 during driving of the vehicle 60 in a case in which a burden of driving on the driver has fallen below a specific reference, and not cause the evaluation information to be output from the monitor 78 and the speaker 79 during driving of the vehicle 60 in a case in which the burden of driving on the driver is the specific reference or greater. In such cases the CPU 61 may, as an example, detect a facial expression of the driver from images captured by the first camera of the camera 76, and estimate the burden of driving on the driver from the facial expression of the driver captured therein.

Although in the exemplary embodiments described above the CPU 61 acquired images capturing the face of the driver as the state of the driver, there is no limitation thereto, and the facial expression of the driver as detected from images capturing the face of the driver may be acquired as the state of the driver. In such cases the CPU 61 is able to acquire, as the state of the driver, whether or not there is sleepiness, distractedness, or tiredness of the driver as the facial expression of the driver.

In the exemplary embodiment described above the CPU 61 counted the number of times in a case in which the evaluation information corresponded to praise information, based on the acquired vehicle information. When doing so the CPU 61 may continuously count the number, and the initialize the count number to “0” in a case in which the evaluation information has corresponded to criticism information countering this praise information. Moreover, the CPU 61 may output the praise information from the monitor 78 and the speaker 79 during driving of the vehicle 60 only in a case in which the count number has been updated a record thereof. Furthermore, the CPU 61 may cause corresponding praise information to be output from the monitor 78 and the speaker 79 during driving of the vehicle 60 at a different output frequency for each of the praise items.

Note that the decision processing executed by the CPU 61 reading software (a program) in the exemplary embodiments described above may be executed by various processors other than a CPU. Such processors include programmable logic devices (PLD) that allow circuit configuration to be modified post-manufacture, such as a field- programmable gate array (FPGA), and dedicated electric circuits, these being processors including a circuit configuration custom-designed to execute specific processing, such as an application specific integrated circuit (ASIC). The decision processing may be executed by any one of these various types of processors, or may be executed by a combination of two or more of the same type or different types of processors (such as plural FPGAs, or a combination of a CPU and an FPGA). The hardware structure of these various types of processors is more specifically an electric circuit combining circuit elements such as semiconductor elements.

Moreover, although in the exemplary embodiments described above an embodiment was described in which the information processing program 64A is pre-stored (installed) in the storage section 64, there is no limitation thereto. The information processing program 64A may be provided in a format stored on a non-transitory storage medium such as a compact disk read only memory (CD-ROM), digital versatile disk read only memory (DVD- ROM), universal serial bus (USB) memory, or the like. The information processing program 64A may also be provided in a format downloadable from an external device over a network N.

What is claimed is:

1. An information processing device comprising a memory, and a processor coupled to the memory, wherein the processor is configured to:
acquire vehicle information related to a vehicle; and
from among a plurality of instances of evaluation information including praise information for praising driving of a driver of the vehicle and including criticism information for criticizing the driving of the driver, cause one of the instances of evaluation information to be output from an output section provided in the vehicle, during driving of the vehicle, based on the acquired vehicle information.

2. The information processing device of claim 1, wherein:
the vehicle information includes at least one of information indicating a driving operation of the driver, a state of the driver, or a current position of the vehicle.

3. The information processing device of claim 1, wherein the processor is further configured to:
count a number of times in a case in which the evaluation information corresponds to the praise information, based on the acquired vehicle information; and
reduce an output frequency at which the praise information is caused to be output from the output section during driving of the vehicle, in a log-periodic manner, as the counted number of times increases.

4. The information processing device of claim 3, wherein the processor is further configured to:
in a case in which the praise information is caused to be output from the output section during driving of the vehicle after a reduction in the output frequency, cause output of content differing to content prior to the reduction of the output frequency.

5. The information processing device of claim 1, wherein the processor is further configured to:
from among the plurality of instances of evaluation information, cause one of the instances of evaluation information that accords with an attribute of the driver to be output from the output section during driving of the vehicle.

6. The information processing device of claim 1, wherein the processor is further configured to determine the output section for outputting the evaluation information during driving of the vehicle from among a plurality of output sections, according to at least one of an attribute of the driver or a current date or time.

7. The information processing device of claim 1, wherein the processor is further configured to:
cause the evaluation information to be output from the output section during driving of the vehicle within a specific period of time from acquisition of the vehicle information.

8. An information processing method executed by a processor, the information processing method comprising:
acquiring vehicle information related to a vehicle; and
from among a plurality of instances of evaluation information including praise information for praising driving of a driver of the vehicle and including criticism information for criticizing the driving of the driver, causing one of the instances of evaluation information to be output from an output section provided in the vehicle, during driving of the vehicle, based on the acquired vehicle information.

9. A non-transitory storage medium storing a program executable by a processor to perform processing, the processing comprising:
acquiring vehicle information related to a vehicle; and
from among a plurality of instances of evaluation information including praise information for praising driving of a driver of the vehicle and including criticism information for criticizing the driving of the driver, causing one of the instances of evaluation information to be output from an output section provided in the vehicle, during driving of the vehicle, based on the acquired vehicle information.
